(19) United States
(12) Patent Application Publication
(10) Pub. No.: US 2003/0066358 A1
(43) Pub. Date: Apr. 10, 2003

(54) Apparatus and method for reducing unwanted microwave reflections in a particulate mass flow rate measuring device

(76) Inventor: Kevin James King, Little Canada, MN (US)

Correspondence Address: DAVID GEORGE JOHNSON, Post Office Box 286, AITKIN, MN, 56431, US

(21) Appl. No.: 09/971,846

(22) Filed: Oct. 4, 2001

(51) Int. Cl. G01F 1/58

(52) U.S. Cl. 73/861.11

(57) ABSTRACT

A scheme for attenuating reflected microwave radiation (11) reflected from distant objects (10) in a flow measuring device. A microwave transducer (3) is mounted on a feedpipe (5) or adjacent to a region in which matrial (2) is permitted to freely fall. The feedpipe (5) permits the introduction of electromagnetic radiation (6) into a larger mass transporting conduit (1). As particulate material (2) passes through the electromagnetic wavefront (7) the reflected signal (9) is sensed by the transducer (3) and the velocity of the material (2) can be calculated. A radar absorbent material (22) is used to line the conduit (1) or surround the region in which material is freely falling, thereby reducing the magnitude of any electromagnetic energy (6) that passes through the absorbent material (22).

### 1. FIELD OF THE INVENTION

This invention relates generally to the field of devices used for measuring the mass flow rate of particulate matter through a conduit, guide or region of free fall and more particularly to those devices which radiate electromagnetic energy toward the particulates flowing within the pipe, conduit or region and subsequently perform data processing of the reflected energy to determine the flow rate.

### 2. BACKGROUND OF THE INVENTION

Ultrasonic methods for determining the presence and rate of a gas/solid two phase flow within a conduit are well known. A typical gas/solid two phase flow, such as coal particles entrained in an air flow, generally comprises a rope like structure of coal particles travelling in the pipe. There are some techniques which attempt to measure the amount of coal in the pipe, but there are drawbacks that make them unacceptable for continuous long term measurements. There are optical methods, but the optical sensors are easily fouled and require frequent maintenance. Other methods require the physical insertion of a probe into the flow path, but the probe(s) either become fouled or are abraded and heated to the point of failure in the harsh environment.

Trial and error methods commonly used in coal power plant operation can result in poor efficiency and increased air pollution. In order to optimize combustion the amount of coal and the amount of air delivered to the burner must be known. Many other examples of powder and granule flow exist in other fields such as the food processing and material manufacturing industries.

One class of flowrate measuring devices transmits microwave energy through the flowing material and a portion of the radiated energy is reflected from the material. At higher flow concentrations, the microwave energy does not penetrate uniformly through the material flow. Much of the energy is reflected by the material or absorbed by the material closest to the to the transducer or transmitter. The material flowing at the farthest or opposite side of the pipe will be exposed to less energy and therefore have less contribution to the total reflected energy received by the transducer or receiver.

Another type of flow measurement device utilizing microwave energy relies on the attenuation of the transmitted energy caused by the material flowing through the conduit. In this method, there is a separate transmitter and a separate receiver. When no material is flowing, the received signal is at a maximum. As the quantity of material flowing within the pipe increases, the received signal is diminished. The amount of flow is generally assumed to be proportional to the decrease in signal strength.

The flow characteristics in multiphase flow, such as the density and location of the flowing material, are not linear functions and instead present a turbulent and chaotic pattern which does not lend itself to straightforward mathematical analysis. The most accurate method of measurement would be to expose all of the flowing material within a pipe to the same levels of electromagnetic energy. This is not usually possible because the transmitter radiates its energy via a directional antenna, typically a horn assembly which is tuned for a specific frequency, direction and beamwidth. The resulting radiated beam may thus illuminate either all or only part of the material flowing through the pipe depending on the beam angle and the distance between the material and the horn antenna. Even if all of the material flow is within the radiation pattern formed by the transmitting horn, the microwave intensity or electromagnetic flux is not uniform throughout the irradiated volume. Some of these signal intensity problems may be corrected by linearization algorithms or by using multiple receivers strategically placed on opposite sides of the conduit to measure the loss of energy caused by either absorption or reflection of the electromagnetic radiation due to the presence of the flowing material. An example of a flow meter using multiple receivers is disclosed in U.S. Pat. No. 5,600,073, issued to Hill.

Microwave flow technology has been shown to work well when the concentrations of material being measured are quite small, that is, the volumetric ratio of coal particles to the conveying airstream, for example, is on the order of 0.001.

Under such circumstances, very little of the radiated microwave signal is reflected or attenuated by the flowing material, resulting in a relatively uniform electromagnetic flux density throughout the volume being measured. The more uniform flux concentration results in a reflected signal that is relatively linear over the range of flowing material concentrations being measured. The low concentrations of material result in a reflected signal of relatively low magnitude, thereby requiring the use of amplification to produce a signal usable for further processing.

The pipe or conduit in which the material is conveyed is frequently of a type that is microwave transparent or which does not block or reflect a major portion of the transmitted microwave signal. The radiated microwave signal may pass from the transmitter through the first wall of the pipe, completely through the flowing material, and then through the second wall of the pipe.

One problem with microwave transparent conduits is that the radiated electromagnetic energy may pass completely through both walls of the pipe and continue into regions beyond the pipe where no flowing material is being transported and hence where no flow measurement is desired. If the radiated energy encounters reflective material beyond the boundaries of the pipe walls, energy may be reflected back through the pipe and the flowing material, eventually being detected by the receiver. As mentioned already, the received signal from the flowing material may be very low due to the low concentrations of particulate matter within the pipe.

A reflection from some large object outside of the pipe, even if relatively distant from the transducer, may produce a received signal that is roughly equivalent in strength to the signal reflected from the flowing material. Such a signal will obviously produce a false indication of the magnitude of material flowing within the pipe.

Simple techniques such as high or low pass filtering may remove some of the unwanted signal depending on the relative frequency attributable to material flowing within the pipe and the frequency of the interfering signal. Usually, the frequency separation is not sufficient to achieve success by this method. Further, there are cases where the unwanted signal is not due to the background movement of people or conveying equipment, but is instead inherent in the flow measuring site. For example, the pipe and transducer, although firmly clamped together, may vibrate or move during normal operation. This creates relative movement between the transducer and any wall or other nearby stationary objects falling within the beamwidth of the horn antenna. This relative movement again results in a false measurement signal. The transducer could be mounted on the wall or floor so as to eliminate this source of relative movement, but then the vibration of the pipe in which the material flows would itself create relative movement with the transducer. While the majority of the radiated signal will pass through the pipe wall there will still be some reflection from the pipe wall itself unless the pipe material has the same electromagnetic properties as the surrounding atmosphere, which is highly unlikely.

In most practical situations the relative movement of the pipe with respect to the transducer will result in an incorrect flow measurement.

In some situations the flowing material which is to be measured is transported within a metallic pipe which is inherently opaque to microwave radiation. In this case the transducer is mounted within another metallic pipe which perforates or penetrates the wall of the material transport pipe such that the radiated energy is permitted to pass into the interior volume of the material transport pipe. A microwave transparent plug may be placed in the end of the feed pipe to prevent material from travelling into the feed pipe and toward the transducer. Since the radiated and reflected microwave signals are confined within the metallic transport and feed pipes, measurement errors cannot be introduced by the relative motion of objects outside of the pipes. However, this method of flow measurement does introduce other problems.

First, the metallic conductor may behave as a waveguide or other resonant or tuned chamber. The conducting material is typically chosen to one of many reasons such as abrasion resistance, static electricity control, explosion proofing, pressure characteristics or structural properties. Substitution of another material in order to create microwave transparency or preserve microwave opacity may not be practical. Under these circumstances the radiated microwave signal may be propagated within the material transport pipe for long distances with minimal attenuation.

Since the particulate matter is usually being conveyed pneumatically, there is typically a fan with its associated moving blades spanning the cross sectional area of the conduit. Reflection of the transmitted electromagnetic energy from the moving blades can create interference and hence degradation of the signal reflected from the material being transported and measured.

A second problem can be caused by vibration of the metallic pipe which can be induced by its attachment to moving machinery such as the aforementioned fan. Since microwave radiation is inherently of very short wavelengths, the physical motion induced by vibration of the pipe may be an appreciable fraction of those wavelengths. Because the metallic pipe is acting as a tuned circuit its vibration or periodic translation through some appreciable fraction of a wavelength can alter the characteristics of the reflected signal in unpredictable and hence uncompensatable ways.

A third problem may be caused by the creation of localized amplitude and phase variations in the reflected signal within the metallic pipe, these variations not being aligned in a predictable way with the radiated microwave beam. These variations or standing waves are caused by the addition and subtraction of the travelling electromagnetic waves within the pipe. The pipe sizes used in conveying the particulate material may be on the order of a few to many wavelengths of the microwave wavelength.

As the microwaves travel through the pipe, they add and subtract in complex ways that would appear almost random but which could in fact be predicted if all of the characteristics of the conducting medium were precisely known. This effect occurs not only along the longitudinal axis of the pipe but also throughout its cross sectional area. The final result of these interactions is a complex three dimensional field. These effects are greatest a short distance from the transducer and decrease as the distance from the transducer becomes greater.

If the material flow through the pipe was constant and homogeneous, the reflected signal attributable to the material flow would be a summation or integration of the signals reflected from the material along the length of the pipe or conductor. Unfortunately, the material often flows in what is termed a “rope”, meaning one or more generally longitudinal strands in which the material concentration is very much higher than in adjacent regions of the pipe. The position of the ropes themselves may vary in a chaotic fashion. This is not to say the mass flowrate is varying in either concentration or velocity. Rather, the instantaneous cross sectional concentration at any given point in the pipe may vary widely and unpredictably. The radiated beam may not intersect a representative region of the pipe cross section at any predictable time, and hence traditional integration techniques will not yield accurate mass flow rate measurements.

### SUMMARY OF THE INVENTION

The present invention addresses some of the problems of the prior art and in particular the problem of false measurements caused by the relative movement of the microwave transducer with respect to other objects. This is accomplished by restricting or confining the radiated and reflected microwave signal to the volume inside the pipe or other conveying guide and by not allowing passage of the microwave signal into a region where other relative movement may be detected. In the present invention a microwave absorbing material is used to prevent the transmitted microwave is signal from leaving the volume where particulate material is actually flowing. The microwave signal is substantially absorbed by the material. Any signal that does pass through the material and is reflected must again pass through the absorbent material before being detected by the transducer. This reduces the presence of false signals to a level where they are either undetectable or not a significant factor with respect to the signal reflected from the flowing material.

In the present invention, the microwave transducer is rigidly affixed to the conveying pipe or conduit. The microwave absorbing material is wrapped around the pipe or conduit in the region adjacent to the transducer. Preferably the transducer assembly as well as the microwave horn, feed or antenna is also wrapped with the absorbent material. An open path must be maintained to permit the radiated transducer signal to illuminate the flowing material within the pipe without obstruction.

The microwave absorbing material is firmly attached to all components so that no relative movement between the material and the transducer can occur. Typically, the radar absorbing material is wrapped within another more durable material in order to provide environmental protection.

With the microwave absorbing material in place, the Doppler shifted microwave signal is reflected from the material moving within the pipe. Any microwave signal that passes through the moving particulate matter and the wall of the pipe encounters the microwave absorbing material. This absorbent material has characteristics that tend to either directly absorb or at least scatter any intercepted microwave energy. Relatively little energy escapes, the exact quantity depending on the specific characteristics of the radar absorbing material being used. Any residual energy that is subsequently reflected back through the pipe wall from moving objects is further attenuated and dissipated by the absorbent material.

The present invention also uses microwave absorbing material to address interference caused by objects moving in the pipe, pipe vibration and by standing wave interference of the microwave field. Since microwave absorbing material cannot typically withstand the environmental conditions within the pipe while particulate material is being transported, such material cannot be used to directly line the interior pipe wall.

The present invention addresses this problem by using a suitably robust microwave transparent material to line the inside of the pipe while maintaining the desired material transport characteristics of the pipe.

A suitable liner material may be plastic or a hard abrasion resistant material such as ceramic or basalt. The microwave absorbing material is wrapped around the pipe liner. The microwave absorbing material is formed to include an opening to permit passage of the microwave signal into the pipe cavity. This microwave absorbent liner assembly is inserted into a larger pipe which has been formed to include the feed pipe which houses the microwave transducer. The entire liner/feed pipe assembly can then be inserted as a substitute section of the particulate matter conveying conduit.

The microwave signal emitted from the transducer will pass through the wall of the liner and into the flowing particulate matter. Some of the radiated signal will be reflected from the flowing material and pass back through the liner to the transducer receiver. Some of the remaining microwave signal will be absorbed by the flowing material but most of it will pass through the opposite wall of the liner and be absorbed, with relatively little of the signal reaching the metallic pipe wall and hence being reflected. Any reflected signal must then pass back through the liner and will be further attenuated to a level that is insignificant to the flow measurement data processing task. A further advantage of the aforementioned scheme is that any reflected signal will have to bounce through the absorbent material numerous times as it propagates along the length of the pipe. Depending on the transducer feed angle and the length of the lined substitute pipe section, the reflected signal will tend to be highly attenuated before reaching an unlined portion of the conveying pipe since each reflected signal bounce requires two passages through the absorbent liner material.

Moving objects within the pipe, such as fan blades, and vibration of the pipe will thus not be at a high enough signal level to affect measurement accuracy. Signal concentrations caused by standing waves are also significantly attenuated since their existence requires reflection from the conductive layer which is blocked by the radar absorbing material.

### BRIEF DESCRIPTION OF THE DRAWINGS

FIG. 1 is a side elevation depicting a first configuration for measuring particulate mass flow;

FIG. 2 is a side elevation depicting a second configuration for measuring particulate mass flow;

FIG. 3 is a side elevation depicting a third configuration for measuring particulate mass flow;

FIG. 4 is a plan view showing a first mass flow measuring device constructed according to the principles of the present invention;

FIG. 5 is a side elevation showing the apparatus depicted in FIG. 4;

FIG. 6 is a side elevation depicting a fourth configuration for measuring mass particulate flow;

FIG. 7 is a plan view depicting a second mass flow measuring device constructed according to the principles of the present invention;

FIG. 8 side elevation of the apparatus depicted in FIG. 7; and

FIG. 9 is a side elevation depicting roping of the particulate flow in a metallic pipe.

### DETAILED DESCRIPTION OF THE PREFERRED EMBODIMENT

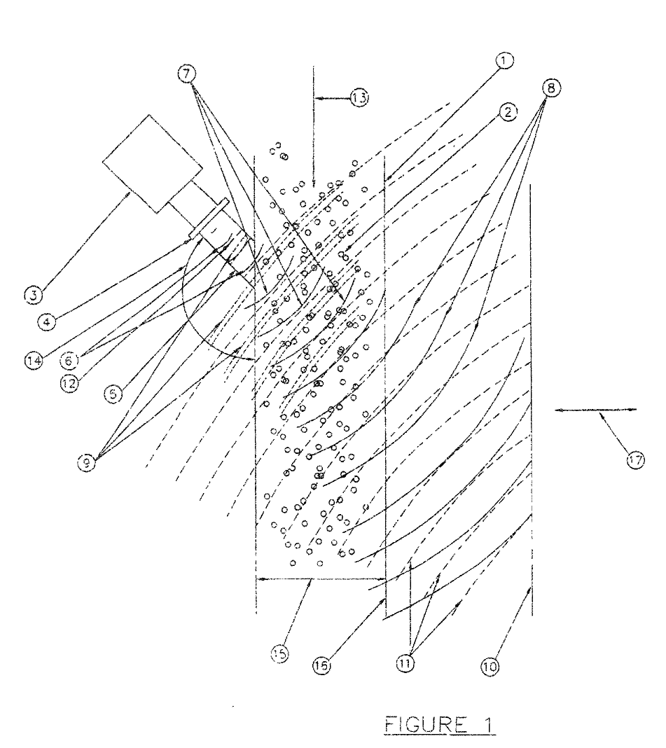

Referring generally to FIG. 1, a particulate matter mass flow measuring scheme is depicted. A nonmetallic pipe 1 is shown through which a granular or powdery material 2 flows in the direction of arrow 13. In order to measure the mass flow rate of the material 2 through the pipe 1 a microwave transducer and its associated electronics 3 is oriented so as to transmit microwave signals 7 across and through the interior volume of pipe 1. In practice, the transducer 3 is affixed to a flange 4 which mechanically couples the transducer 3 to a feed pipe 5. The feed pipe 5 is formed so as to present an un obstructed path to emitted microwave radiation 6 leaving the transducer 3 and aimed at the particulate material 2 within pipe 1. The angle 14 at which the feed pipe enters the conveying pipe 1 cannot be ninety degrees, but must orient the feedpipe either upstream or downstream. A ninety degree angle will not work because of the need to obtain a Doppler shifted signal. A microwave signal pointed across the direction of flow will provide only an indication of flow moving laterally across the pipe. Theoretically the best position for the emitted signal source would be aimed longitudinally directly down the pipe, but this cannot be practically achieved in this case. In practice, the beam source is at as great a departure from ninety degrees as possible, keeping in mind that very oblique angles are not practical either. If the angle chosen is very slight, the emitted microwave signals have a much longer distance to travel to the material 2 and back to the transducer 3, thereby compromising sensitivity. The specific angle chosen is dependent on several factors such as the diameter 15 of pipe 1, the wavelength of the emitted microwave signal and the expected velocity of the material 2 as it flows through pipe 1.

Some of the emitted signal 6 passes through the interior of pipe 1 as radiation 7, and that electromagnetic energy which is not reflected or absorbed continues through the wall 16 of pipe 1 as electromagnetic wave 8. Often there is a vibrating or moving object 10 in a region that is adjacent to conveying pipe 1, the direction of movement or vibration being depicted by arrow 17. A portion of the electromagnetic waves 8 will encounter the vibrating object 10 and be reflected as reflected signal 11. A small amount of the reflected signal 11 will reenter feed pipe 5 where it will be sensed by transducer 3 as reflection 12. The reflection 12 will generally be indistinguishable from desired signal 9 which is produced by the reflection of transmitted signal 6 as it encounters the flowing material 2 within pipe 1.

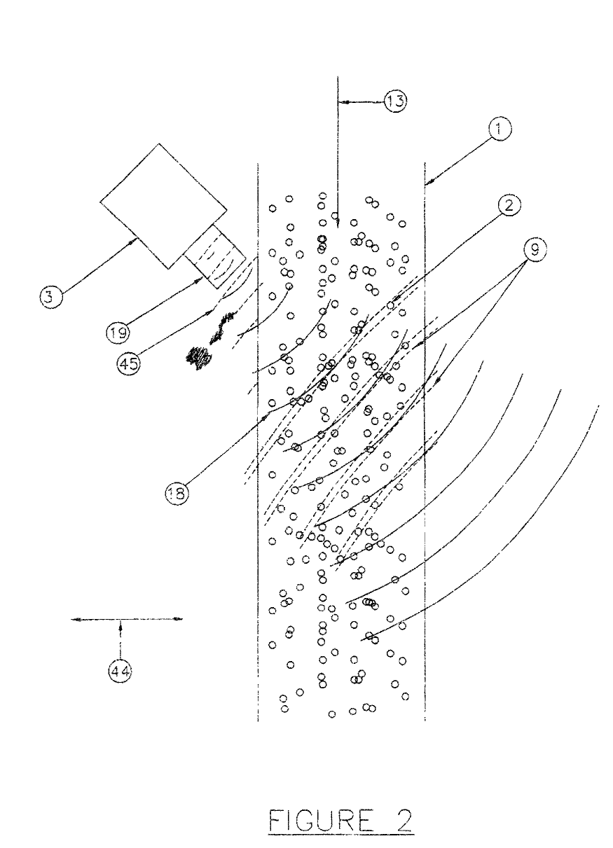

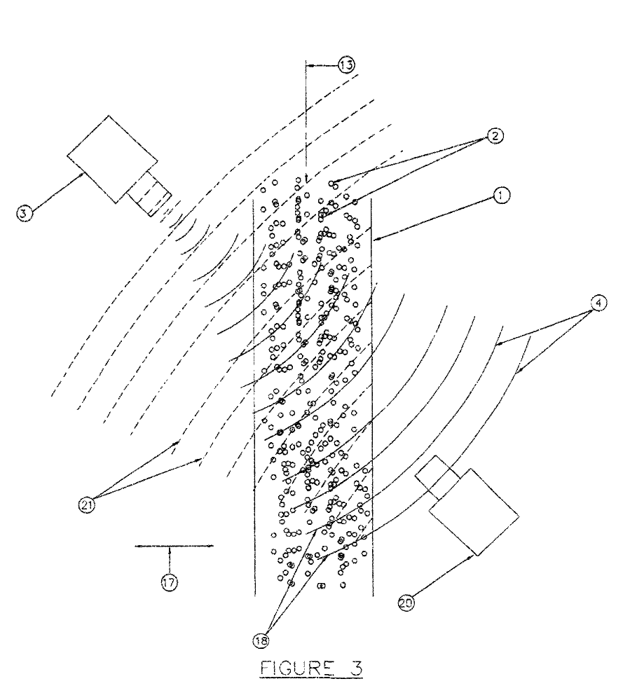

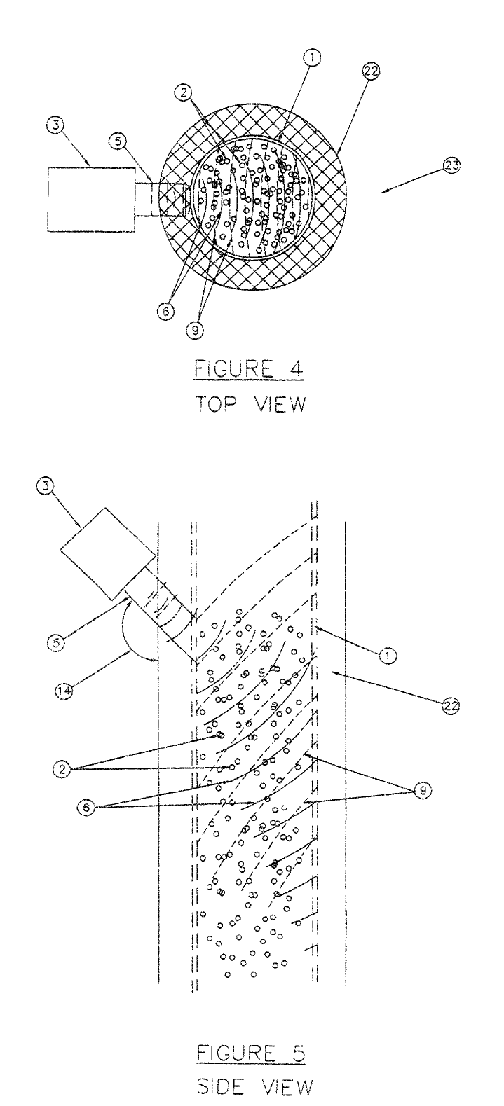

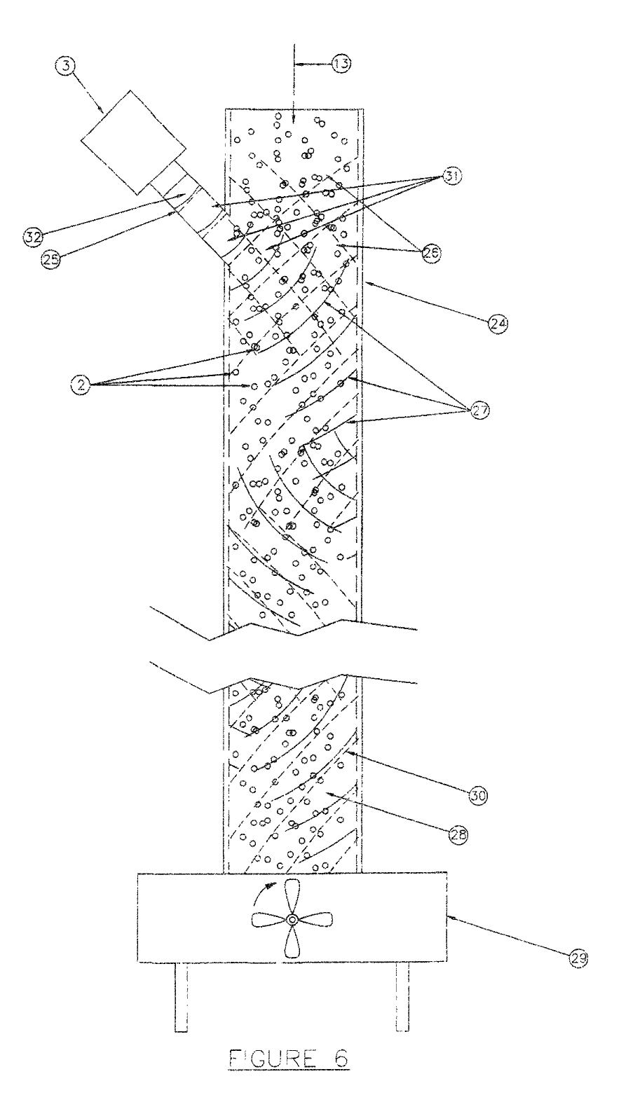

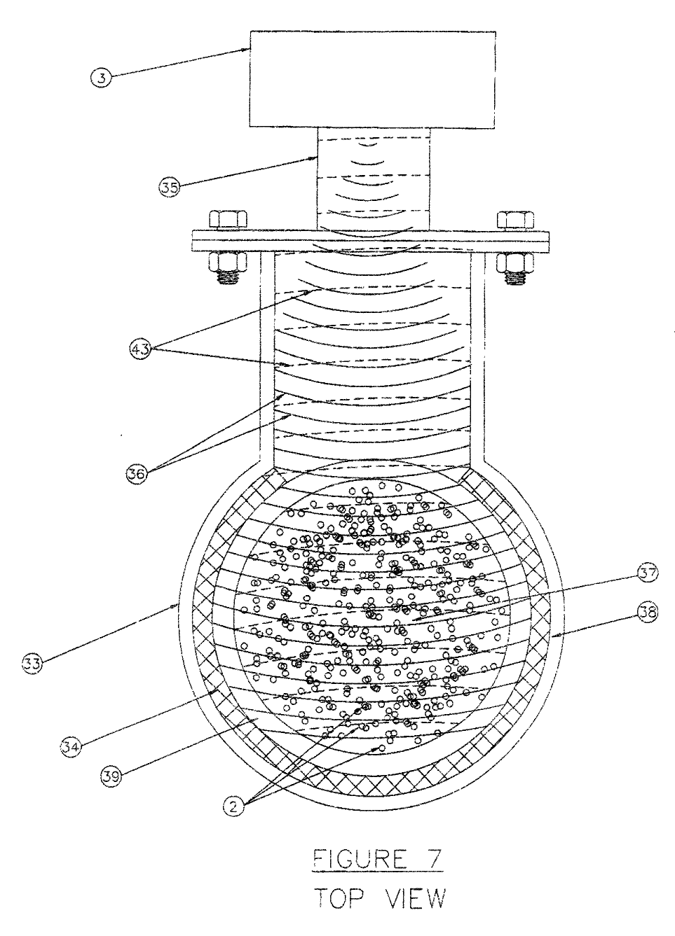

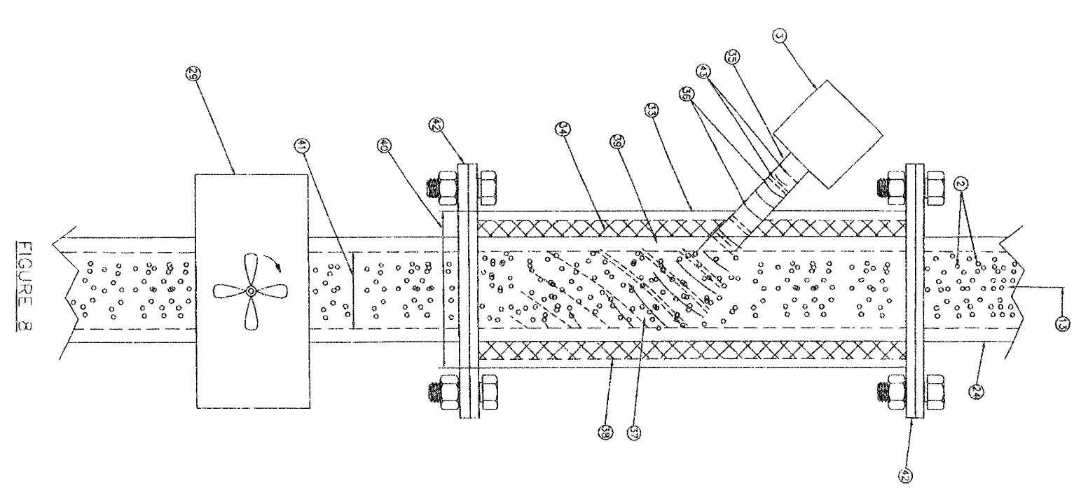

Referring also to FIG. 2, an alternate flow measuring scheme is shown in which the transducer is mounted adjacent to the nonmetallic pipe 1 without being rigidly affixed to the pipe 1.

The flowing material 2 travels in the direction of arrow 13. The signal 18 emitted by the transducer 3 is free to travel through the pipe 1 and has a radiation pattern that is determined primarily by the characteristics of transducer antenna 19. Part of the transmitted signal 18 in the pipe 1 is reflected as signal 9 to transducer 3 and received as detected signal 45. 10 While this arrangement presents a more uniform flux density to the measured material 2, relative movement 42 between the transducer 3 and pipe 1 is now possible. Further, the radiated signal 18 may be reflected from both the inside as well as the outside of pipe 1. Relative motion between the transducer 3 and pipe 1 (or any external vibrating object) results in a modulation of the detected signal 45 which is received by transducer 3. The relative motion may be of a nature such that the resulting detected signal 45 is indistinguishable from the Doppler shifted signal 9 produced by interaction with the flowing product 2.

One should emphasize that the signal which is reflected back into transducer 3 by the pipe wall or any other object outside of the pipe 1 is not always a problem. If there is no relative motion between transducer 3 and pipe 1 (or other external object) then the reflected signal produced by such interaction is not Doppler shifted. As an unshifted signal, the transducer 3 and its associated software and signal processing electronics recognize this reflected signal as a stationary component and hence is a component that does not contribute to the flow of product 2. However, if there is relative motion between the transducer 3 and any object, the relative movement will result in a Doppler shifted reflected signal which may be indistinguishable from the Doppler shifted signal 9 produced by the moving particle flow 2.

Referring also to FIG. 3, another flow measuring arrangement is depicted. The microwave transducer 3 is mounted adjacent to but not affixed to pipe 1, and a separate receiver 20 is mounted opposite to the transducer 3 such that signals passing between transducer 3 and receiver 20 must pass through the pipe 1 and particulate matter 2. In this arrangement, the transmitted wave 18 is sensed directly by the receiver 20. Further, while the transducer 3 may be only a transmitter, the transducer 3 may also be a transceiver capable of receiving the reflected waves 21. In this case a comparison of the signals received by receiver 20 and those received by transducer 3 may be compared to produce more accurate flow measurement data. However, this arrangement still permits vibration and relative movement 17 between the pipe 1, transducer 3 and receiver 20, so much of the accuracy gains could be lost by the presence of false or undesired motion signals.

The use of a microwave absorbing material 22 can be seen in the arrangement of FIGS. 4 and 5, in which the nometallic pipe 1 depicted in FIG. 1 is surrounded or encased by the absorbent material 22. The microwave transceiver 3 emits a signal 6 through feed pipe 5 which enters pipe 1. The emitted signal 6 encounters the flowing material 2. Some of the emitted signal 6 is reflected from the particulate material 2, thereby producing the Doppler shifted reflected signal 9. Some of the reflected signal 9 enters feed pipe 5 where it is received by transceiver 3.

The angle 14 is selected so that the transmitted signal 6 encounters or senses a relatively high material flow velocity, which thereby tends to maximize the magnitude of the frequency shift of reflected signal 9. A portion of the originally transmitted signal 6 is also mixed with received signal 9 within the transceiver 3. The result of this mixing is to create a difference or image frequency in the output of the receiver portion of transceiver 3 according to the formula:

dF=1 Fr−Ft 1=(2*v*Ft)/c

where

dF=the low frequency doppler signal in the receiver output

Ft=the transmitting or emitted frequency 6

Fr=the frequency of the doppler shifted reflected signal 9

v=the speed of the target particulate material 2

c=the speed of light (300,000,000 meters/second)

In practice, the flowing material 2 includes portions that are flowing at different velocities, which results in a distribution of received signals 9 of differing amplitudes and differing frequencies. Within the transceiver 3 or connected to it is an amplifier and filter which amplifies the low frequency Doppler signal spectrum dF and which also removes extraneous noise signals.

The amplified Doppler signal is digitized by circuitry (not shown) associated with the transceiver 3 using a high speed analog to digital converter. The sampling rate used by the converter is chosen to satisfy the Nyquist criteria for accurately determining the maximum frequency of interest within the Doppler signal dF. The sample period (sample rate * number of samples) must allow for determination of the lowest frequency of interest in the Doppler signal dF.

The next step performed by the processing circuitry of transceiver 3 is to process the array of digitized samples by an appropriate spectral analysis program, such as the Fast Fourier Transform (FFT), which generates an array of signal amplitude versus frequency from the original sample array. Each value of the FFT array corresponds to the amplitude of the received microwave signal that falls within a fixed range of frequencies.

The amplitude value for each frequency in the spectral analysis is then squared to convert the array to a power spectrum instead of an amplitude spectrum. At this point the power level of the received microwave signal within each frequency range is proportional to the mass density of only the material 2 flowing at the range of velocities which corresponds to that range of frequencies.

A numeric integration is then performed on the power spectrum as follows: The power level P at each frequency step n is multiplied by the value of n and then each of these product terms is summed. The basic mass flow rate is defined as:

Mass Flow Rate=mass density*flow velocity*flow cross section

Since the flow cross sectional area is a constant, the total mass flow rate can be defined as the sum of the mass density of the material flowing at a given velocity multiplied by that corresponding velocity. Each of the numeric integration terms describes the mass flow rate of only the material flowing at the range of velocities which corresponds to that frequency and thus the velocity step n. The sum of all of these terms is proportional to the total mass flow rate.

That portion of the emitted signal 6 which is not reflected from or absorbed by the flowing material 2 travels through the wall of pipe 1 and into the radar absorbent material 22. A relatively large amount of the emitted signal 6 which enters material 22 is absorbed, leaving very little of the signal 6 to enter the region 23 which lies beyond pipe 1. If the highly attenuated remains of signal 6 encounter any object such as object 10 shown in FIG. 1, the reflection produced will be extremely weak and will have to reenter the absorbent material 22 in order to be sensed by transceiver 3. By reentering the absorbent material 22 the already weak signal will be further attenuated to the point where its signal strength is negligible. In this manner the effect of any vibrating object in region 23 on the accuracy of the flow measurement of particulate material 2 will be substantially reduced or eliminated by the presence of the radar absorbing material 22 on the exterior of the nonmetallic pipe 1.

Referring to FIG. 6, the problem of flow measurement when using a metallic pipe 24 is presented. The microwave transceiver 3 is connected to a metallic feed pipe 25 which is rigidly affixed to metallic material conveying pipe 24. The transceiver emits within the feedpipe an initially high intensity signal 32. The pipe 24 acts as a waveguide in this configuration, allowing much of the gradually weakening radiated signal 31 to be reflected back to the transceiver 3.

The signal 31 travels along pipe 24 with little attenuation, becoming the propagated signal 27 which eventually encounters some moving object such as the blower fan 29. The moving object may or may not be directly in the conduit pipe 24 insofar as the signal is readily propagated throughout the interior of, for example, metallic boxes and chutes which may be part of the associated material flow hardware in an actual real world installation. In any event, the object such as fan 29 reflects some downstream radiation 28 as a Doppler shifted signal 30, some of which successfully makes the return trip through pipe 24 and which is received by transceiver 3. The Doppler shifted signal 30 may be indistinguishable from the material flow induced signal 26. In some cases the Doppler shifte signal 30 may be of a magnitude which is much greater than the signal 26 produced by reflections of signal 31 from the material flow.

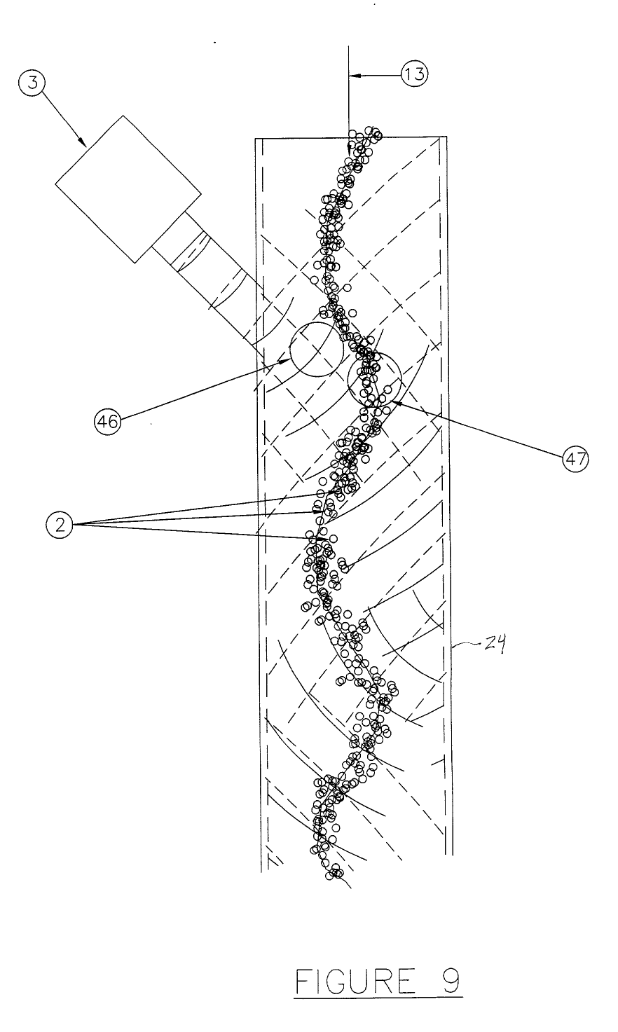

With the foregoing in mind, FIG. 9 shows particulate flow in a metallic pipe where roping occurs. As mentioned previously, the particulate flow may form “ropes” or “bands”. These ropes generally are in the center portion of the pipe but frequently move throughout the pipe in a chaotic fashion.

When microwave signals 31 are emitted from transceiver 3 and the propagated signals 27 encounter reflected signals 30, variations in microwave field intensity within the pipe 24 occur, resulting in microwave intensities which are much greater at one point within pipe 24 than at another location which is quite nearby. The patterns of varying field intensity are caused by the constructive and destructive interference of the primary transmitted signal 31, the multiple reflected signals 26, 27 and propagated signals 30.

The magnitude of the returned signal 26 is upon the mass and physical characteristics of the flowing material 2, the quantity of the material 2 and the intensity of the transmitted signal 31. The returned signal 26 will also be dependent upon the absolute position of the mass flow 2 within the pipe. If region 46 represents a region of relatively low microwave flux and region 47 represents a region of relatively high microwave flux, the transit of roped material 2 from region 46 to region 47 will result in a dramatically different return signal 26 to transceiver 3, even though the mass flow rate through pipe 24 has remained relatively constant.

As seen in FIGS. 7 and 8, the present invention may be used advantageously by substituting an entire section of metallic pipe 1 with an entire section 33 which has been formed to include a liner of microwave absorbent material 34. The substitute section is affixed to the existing pipe at flange 42. The microwave transceiver 3 is attached to feed pipe 35 and aligned along the axis of the feed pipe 35 to emit microwaves 36 into the interior 37 of the substitute pipe section 33.

The substitute section 33 is preferably constructed so as to have a metallic exterior. The inner wall 38 of section 33 is lined with radar absorbing material 34, which is protected by a microwave transparent liner 39. The emitted waves 36 pass through the liner 39 and into the area of the flowing material 2. Some of the microwave signal 36 is reflected by the material 2, the reflected signal 43 passing back through the feedpipe 35 and into the transducer 3. This signal is reflected amplified, filtered and analyzed to determine the mass flow rate. The microwave signal 36 that is not reflected or attenuated by material 2 continues traveling until recontacting the liner 39 and passing into the microwave absorbing material 34, where the emitted signal 36 is attenuated. This attenuation retards the reflection of the microwave signal back into the pipe 33, thus substantially eliminating the problem of further reflections downstream in the pipe where moving objects may be encountered. Further, the attenuation of signal 36 inhibits the relatively high intensity localized microwave flux caused by standing waves created by interaction with the otherwise present reflection of signal 36. Also note that the outer diameter 40 of section 33 is greater than the inner diameter 41 of pipe 24. This is necessary so that there will be no aerodynamic discontinuity to the flow of material 2 within pipe 24 and through section 33. Changes in the flow properties result in chaotic turbulent flow which makes flow measurement more difficult. In general this arrangement results in the vast majority of reflected energy 43 which reaches transceiver 3 being the result of Doppler shifted interaction with the flowing particulate matter 2 as opposed to reflections from object 29 which lie beyond the boundaries of section 33.

Flow Rate Measuring Apparatus Parts List

| | |
|---|---|
| 1 | Pipe |
| 2 | Flowing Material |
| 3 | Transducer |
| 4 | Flange |
| 5 | Feed Pipe |
| 6 | Emitted Signal |
| 7 | Microwave Signal |
| 8 | Electromagnetic Wave |
| 9 | Desired Signal |
| 10 | Vibrating Object |
| 11 | Reflected Signal |
| 12 | Reflection |
| 13 | Direction of Arrow |
| 14 | Angle |
| 15 | Diameter |
| 16 | Wall |
| 17 | Arrow |
| 18 | Transmitted Signal |
| 19 | Transducer Antenna |
| 20 | Separate Receiver |
| 21 | Reflected Waves |
| 22 | Absorbent material |
| 23 | Region |
| 24 | Material Conveying Pipe |
| 25 | Metallic Feed Pipe |
| 26 | Material Flow Induced Signal |
| 27 | Propagated Signals |
| 28 | Downstream Radiation |
| 29 | Fan |
| 30 | Doppler Shifted Signal |
| 31 | Gradually Weakening Radiated Signal |
| 32 | High Intensity Emitted Signal |
| 33 | Substitute Section |
| 34 | Microwave Absorbing Material |
| 35 | Feed Pipe |
| 36 | Microwave Signal |
| 37 | Interior |
| 38 | Inner Wall |
| 39 | Microwave Transparent Liner |
| 40 | Outer Diameter |
| 41 | Inner Diameter |
| 42 | Flange |
| 43 | Reflected Energy |
| 44 | Relative Movement |
| 45 | Detected Signal |
| 46 | Region |
| 47 | Region |

I claim:

1. An apparatus for measuring the flow rate of a flowing material, comprising:
(a) at least one transmitter and one receiver acting as a transducer, the transducer emitting and receiving electromagnetic radiation;
(b) a path, the path defining a region within which the flowing material flows; and
(c) an electromagnetic absorbing material, the electromagnetic absorbing material being arranged along the path so as to permit the introduction of electromagnetic radiation substantially only from the transducer to the path.

2. The apparatus of claim 1, wherein the path is formed so as to comprise:
(a) a pipe; and
(b) an inlet orifice, the inlet orifice being formed within a sidewall of the pipe so as to permit the introduction of electromagnetic energy from the transducer into the pipe.

3. The apparatus of claim 2, wherein the pipe further comprises an outer wall, the electromagnetic absorbing material being arranged upon the pipe so as to line the outer wall.

4. The apparatus of claim 3, wherein the transducer is rigidly affixed to the pipe so as to substantially eliminate relative movement between the pipe and the transducer.

5. The apparatus of claim 4, wherein the transducer is formed to include an outer surface, at least a portion of the outer surface being covered with the electromagnetic absorbing material.

6. The apparatus of claim 5, further comprising a radiation transparent protective shield, the radiation transparent protective shield being arranged so as to cover the electromagnetic absorbing material and prevent contact between the flowing material and the electromagnetic absorbing material.

7. The apparatus of claim 6, wherein the transducer further comprises an antenna, the antenna being formed to include an outlet orifice through which the electromagnetic radiation is sent and received by the transducer.

8. The apparatus of claim 7, further comprising an interconnection pipe, the interconnection pipe being affixed at a first end to the transducer, the interconnection pipe being affixed at a second end to the inlet orifice formed within the sidewall of the pipe, thereby permitting electromagnetic communication between the outlet orifice of the transducer and an interior region of the pipe.

9. The apparatus of claim 8, wherein the electromagnetic absorbing material is arranged so as to cover at least a portion of the interconnection pipe.

10. The apparatus of claim 9, wherein the transducer emits and receives electromagnetic radiation at microwave frequencies.

11. An apparatus for attenuating propagation of electromagnetic energy within a metallic pipe used for transporting a flowable material, comprising:
(a) an electromagnetic absorbing material arranged so as to abut an inner sidewall of the metallic pipe; and
(b) a radiation transparent coating arranged so as to envelop at least a portion of the electromagnetic absorbing material, thereby protecting the electromagnetic absorbing material from the flowable material within the pipe.

12. The apparatus of claim 11, further comprising an orifice formed within the inner sidewall of the metallic pipe so as to permit introduction of electromagnetic energy to an interior region of the electromagnetic pipe.

13. The apparatus of claim 12, further comprising:
(a) a transducer, the transducer being capable of emitting electromagnetic radiation at microwave frequencies; and
(b) a feed pipe, the feedpipe being rigidly affixed to the transducer and the metallic pipe, the feedpipe permitting the introduction of electromagnetic energy from the transducer through the orifice formed within the inner sidewall of the metallic pipe.

14. A method of attenuating microwave radiation and propagation within a pipe used to transport a flowable material, comprising the steps of:
(a) forming a section of pipe which may be fastened in a serial fashion to other pipes to form a continuous conduit; and
(b) lining the section of pipe with a microwave absorbent material so as to attenuate microwave radiation within the section of pipe.

15. The method of claim 14, further comprising the step of forming an orifice through a sidewall of the section of the pipe so as to permit the introduction of microwave radiation into an interior region of the section of pipe.

16. The method of claim 15, further comprising the step of mounting a feedpipe to the sidewall of the section of pipe so as to be aligned with the orifice formed in the sidewall of the section of pipe, thereby permitting electromagnetic radiation within the feedpipe to enter the section of pipe.

17. The method of claim 16, further comprising the step of covering the microwave absorbent material within the section of pipe with a radiation transparent material, thereby protecting the microwave absorbent material from material flowing within the section of pipe.

18. The method of claim 17, further comprising the step of affixing a microwave transducer to the feedpipe so as to permit radiation from the transducer to travel through the feedpipe into the section of pipe.

19. The method of claim 18, further comprising the step covering at least a portion of the microwave transducer with a microwave absorbent material.

20. The method of claim 19, further comprising the step of substituting the section of pipe for an existing section of pipe in an existing material flow transporting apparatus.
